(19) United States
(12) Patent Application Publication
(10) Pub. No.: US 2022/0232118 A1
(43) Pub. Date: Jul. 21, 2022

(54) Smart Plate Device

(71) Applicant: John Althausen, Loudon, TN (US)

(72) Inventor: John Althausen, Loudon, TN (US)

(21) Appl. No.: 17/574,679

(22) Filed: Jan. 13, 2022

Related U.S. Application Data
(60) Provisional application No. 63/139,829, filed on Jan. 21, 2021.

(51) Int. Cl. H04M 1/72418; G06F 3/16; H04M 1/72436; G08B 7/06

(52) U.S. Cl. CPC H04M 1/72418; G08B 7/06; H04M 1/72436; G06F 3/167

(57) ABSTRACT

The present invention relates generally to the field of cover plates. More specifically, the present invention relates to a smart plate device. The device is primarily comprised of a front plate that has a top surface, a side surface, and a rear surface further comprised of a box. The device can be installed as a cover plate for a light switch and/or a power outlet. Multiple devices can further be used in an intercom-like fashion within a home. Further, the device may have or be compatible with a virtual smart assistant that can be used to control the device and its functions. The device is also illuminated via an LED and can be controlled by the voice of the user.

### CROSS-REFERENCE TO RELATED APPLICATION

The present application claims priority to, and the benefit of, U.S. Provisional Application No. 63/139,829, which was filed on Jan. 21, 2021, and is incorporated herein by reference in its entirety.

### FIELD OF THE INVENTION

The present invention relates generally to the field of cover plates. More specifically, the present invention relates to a smart plate device. The device is primarily comprised of a front plate that has a top surface, a side surface, and a rear surface further comprised of a box. The device can be installed as a cover plate for a light switch and/or a power outlet. Multiple devices can further be used in an intercom-like fashion within a home. Further, the device may have or be compatible with a virtual smart assistant that can be used to control the device and its functions. The device is also illuminated via an LED and can be controlled by the voice of the user. Accordingly, the present disclosure makes specific reference thereto. Nonetheless, it is to be appreciated that aspects of the present invention are also equally applicable to other like applications, devices and methods of manufacture.

### BACKGROUND

All homes have a plurality of light switches and power outlets. However, beyond allowing a user to turn lights on/off and plug items in to receive power, light switches and power outlets lack many other helpful features. For example, if a home emergency occurs a homeowner may be unable to contact emergency services if a phone is not nearby. In addition, if a homeowner does not have a free hand, they are typically unable to activate a light switch. In addition, a homeowner must be physically in front of a light switch to activate the switch. Further, some light switches and power outlets cannot be easily located in dark rooms because they are not illuminated.

Therefore, there exists a long-felt need in the art for an improved light switch and power outlet cover plate. There also exists a long-felt need in the art for a smart plate device that can be used as a light switch cover plate and power outlet cover plate, wherein the device illuminates to make it easy to locate. In addition, there exists a long-felt need in the art for a smart plate device that can be used as a light switch cover plate and power outlet cover plate, wherein the device allows a user to contact emergency services without the use of a phone. Furthermore, there exists a long-felt need in the art for a smart plate device that can be used as a light switch cover plate and power outlet cover plate, wherein the device has a plurality of smart features not found on current light switch and wall outlet cover plates.

The subject matter disclosed and claimed herein, in one embodiment thereof, comprises a smart plate device. The device is primarily comprised of a front plate that has a top surface, a side surface, and a rear surface further comprised of a box. The device can be installed as a cover plate for a light switch and/or a power outlet. Multiple devices can further be used in an intercom-like fashion within a home. Further, the device may have or be compatible with a virtual smart assistant that can be used to control the device and its functions. The device is also illuminated via an LED and can be controlled by the voice of the user.

In this manner, the smart plate device of the present invention accomplishes all of the forgoing objectives and provides an improved light switch and power outlet cover plate which illuminates, making the device easy to locate. In addition, the device allows a user to contact emergency services without the use of a phone. Further, the device has a plurality of smart features not found on current light switch and wall outlet cover plates.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart plate device. The device is primarily comprised of a front plate that has a top surface, a side surface, and a rear surface further comprised of a box. The front plate and box are preferably manufactured from a durable, rigid plastic, wood, or metal material known in the art. In differing embodiments, the front plate and box may be any shape known in the art. However, the front plate and box are preferably both generally rectangular shaped.

The top surface of the front plate may have at least one light switch or at least one power outlet. The top surface may also be comprised of a touch screen or display screen that displays and/or allows a user to control the functions of the device. The top surface may also have at least one continuous opening that receives at least one fastener that allows the front plate to be secured to the box. The box sits within a wall cavity and is further comprised of a plurality of sidewalls and a bottom surface that may be comprised of at least one continuous opening that allows the box to be fastened to a wall surface using at least one fastener. The sidewalls of the box may further be comprised of at least one terminal that allows out, in, and ground wires to be attached to the device to supply electrical power to a battery of the device.

The top surface may also have at least one button, at least one speaker, and at least one microphone. The microphone allows one user to speak into the device to speak to another user who is near another device such that users in differing rooms can use devices within each room as an intercom system. The button further allows a user to activate or mute the speaker and/or microphone, and may also be used to control the light switch or to turn the device on or off.

The device is also comprised of a mobile application that communicates with at least one transmitter which transmits a Wi-Fi, Bluetooth, RFID, etc. signal that places the mobile application in electrical communication with the front plate. The mobile application may have a voice-activated smart assistant such that functions of the device can be controlled via various voice commands directed at the smart assistant. Using the smart assistant, the device can be used to make a phone call or text message, used to control other smart devices, used to turn the light switch of the front plate on or off, and used to turn the power supply to the power outlet on or off.

Accordingly, the smart plate device of the present invention is particularly advantageous as it provides an improved light switch and power outlet cover plate. The device illuminates, thus making the device easy to locate. Further, the device allows a user to contact emergency services without the use of a phone and has a plurality of smart features, such as a voice assistant, not found on current light switch and wall outlet cover plates. In this manner, the smart plate device overcomes the limitations of existing light switch and power outlet cover plates known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a smart plate device of the present invention in accordance with the disclosed architecture;

FIG. 2 illustrates a front view of one potential embodiment of a smart plate device of the present invention in accordance with the disclosed architecture;

FIG. 3 illustrates a front view of one potential embodiment of a smart plate device of the present invention in accordance with the disclosed architecture;

FIG. 4 illustrates a rear view of one potential embodiment of a smart plate device of the present invention in accordance with the disclosed architecture;

FIG. 5 illustrates a rear perspective view of one potential embodiment of a smart plate device of the present invention in accordance with the disclosed architecture; and

FIG. 6 illustrates a graphical view of one potential embodiment of a mobile application of a smart plate device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved light switch and power outlet cover plate that illuminates to make it easy to locate. In addition, there exists a long-felt need in the art for a smart plate device that can be used as a light switch cover plate and power outlet cover plate, wherein the device allows a user to contact emergency services without the use of a phone. Furthermore, there exists a long-felt need in the art for a smart plate device that can be used as a light switch cover plate and power outlet cover plate, wherein the device has a plurality of smart features not found on current light switch and wall outlet cover plates.

The present invention, in one exemplary embodiment, is comprised of a smart plate device primarily comprised of a front plate that has a top surface, a side surface, and a rear surface further comprised of a box. The front plate and box are preferably manufactured from a durable, rigid plastic, wood, or metal material known in the art. Further, the front plate and box are preferably both generally rectangular shaped.

The top surface of the front plate may have at least one light switch or at least one power outlet. The top surface may also be comprised of a touch screen or display screen that displays and/or allows a user to control the functions of the device. Further, the top surface may also have at least one continuous opening that receives at least one fastener that allows the front plate to be secured to the box. The box sits within a wall cavity and is further comprised of a plurality of sidewalls and a bottom surface that may be comprised of at least one continuous opening that allows the box to be fastened to a wall surface using at least one fastener. Additionally, the sidewalls of the box may further be comprised of at least one terminal that allows out, in, and ground wires to be attached to the device to supply electrical power to a battery of the device.

The top surface may also have at least one button, at least one speaker, and at least one microphone, wherein the microphone allows one user to speak into the device to speak to another user who is near another device such that users in differing rooms can use devices within each room as an intercom system. The button further allows a user to activate or mute the speaker and/or microphone. In addition, the button may also be used to control the light switch or to turn the device on or off.

The device is also comprised of a mobile application. The mobile application communicates with at least one transmitter of the front plate, which transmits a Wi-Fi, Bluetooth, RFID, etc. signal that places the mobile application in electrical communication with the front plate. The mobile application may have a voice-activated smart assistant such that functions of the device can be controlled via various voice commands directed at the smart assistant. Using the smart assistant, the device can be used to make a phone call or text message, used to control other smart devices, used to turn the light switch of the front plate on or off, and used to turn the power supply to the power outlet on or off.

Accordingly, the smart plate device of the present invention is particularly advantageous as it provides an improved light switch and power outlet cover plate. The device illuminates, thus making the device easy to locate. Further, the device allows a user to contact emergency services without the use of a phone and has a plurality of smart features, such as a voice assistant, not found on current light switch and wall outlet cover plates. In this manner, the smart plate device overcomes the limitations of existing light switch and power outlet cover plates known in the art.

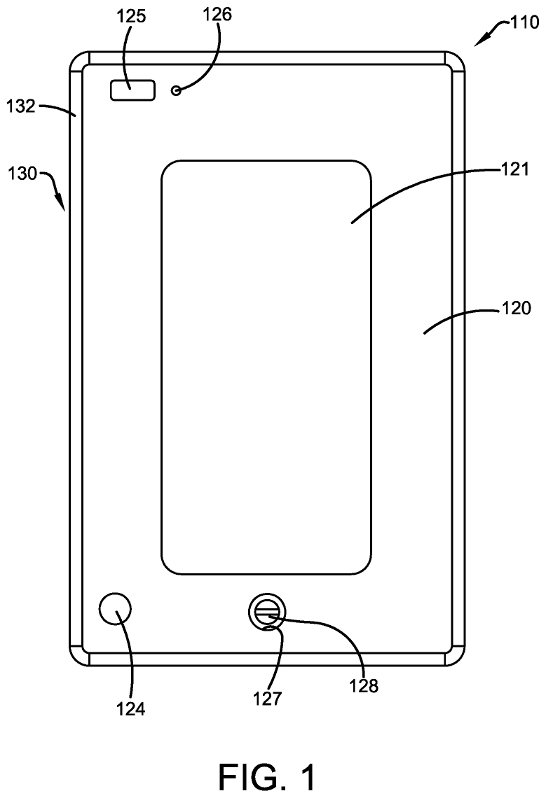

Referring initially to the drawings, FIG. 1 illustrates a front view of one potential embodiment of a smart plate device 100 of the present invention in accordance with the disclosed architecture. The device 100 is primarily comprised of a front plate 110 that has a top surface 120, a side surface 130, and a rear surface 140 further comprised of a box 150. The front plate 110 is preferably manufactured from a durable, rigid plastic such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The front plate 110 may also be manufactured from any wood or metal material known in the art. Similarly, the box 150 may be manufactured from the same material as the front plate 110. The front plate 110, side surface 130, rear surface 140, and/or box 150 may further be comprised of a plurality of indicia 160 such as, but not limited to: patterns, logos, textures, emblems, images, symbols, designs, letters, numbers, words, characters, animals, advertisements, brands, etc. In differing embodiments, the front plate 110 and box 150 may be any shape known in the art. However, the front plate 110 and box 150 are both generally rectangular shaped in the preferred embodiment of the device 100.

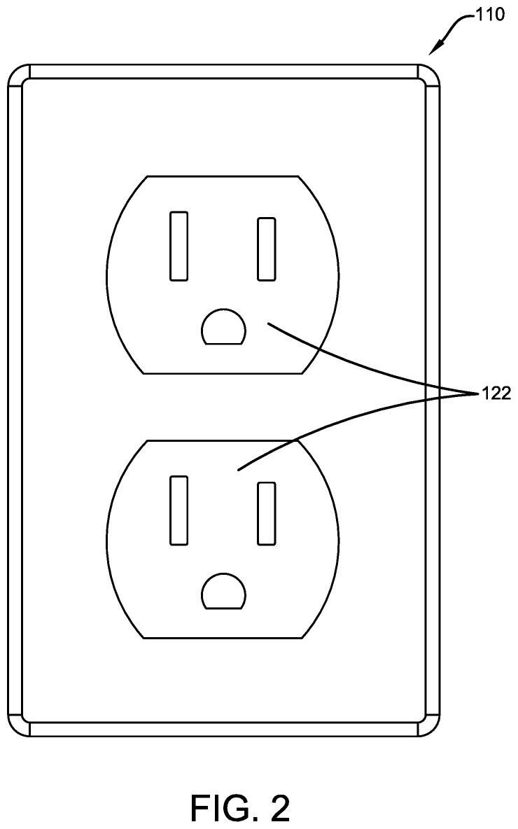

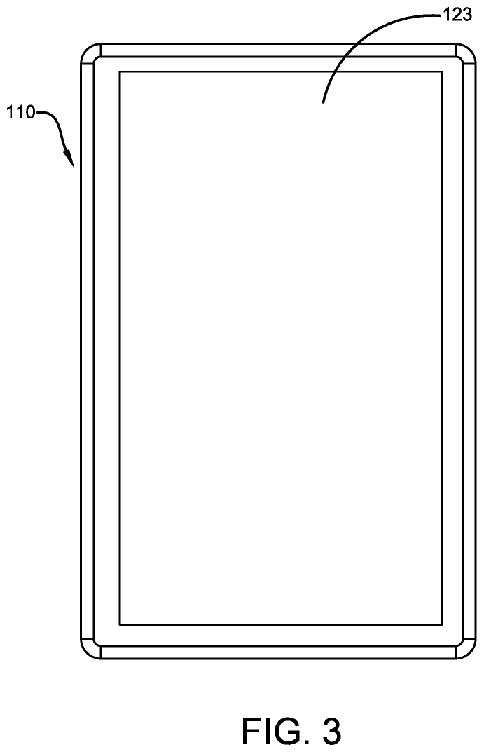

In differing embodiments, the top surface 120 of the front plate 110 may have a plurality of structures. In one embodiment, the device 100 can be used as a light switch to control lights within a home or other structure, wherein the front plate 110 is further comprised of at least one light switch 121. The light switch 121 may be any shape, size, and dimension known in the art, and may be generally flat or may protrude outwards away from the top surface 120. In a differing embodiment seen in FIG. 2, the top surface 120 is comprised of at least one power outlet 122. In one embodiment, the outlet 122 is a female 110V or 240V outlet. Alternatively or additionally, the outlet 122 may be a USB port such as, but not limited to: USB-A, USB-B, Micro-B, Micro-USB, Mini-USB, USB-C, etc. In a further embodiment, the top surface 120 may be comprised of a touch screen 123 or display screen that displays and/or allows a user to control the functions of the device 100, as seen in FIG. 3.

The top surface 120 may also have at least one continuous opening 127 that receives at least one fastener 128 such as, but not limited to: a screw, a bolt, a nail, etc. that allows the front plate 110 to be secured to the box 150. In another embodiment, the front plate 110 is fixedly connected to the box 150, wherein the box contacts the rear surface 140 of the front plate 110. The box 150 sits within a wall cavity and is further comprised of a plurality of sidewalls 152 and a bottom surface 153 that may be comprised of at least one continuous opening 151 that allows the box 150 to be fastened to a wall surface using at least one fastener 128.

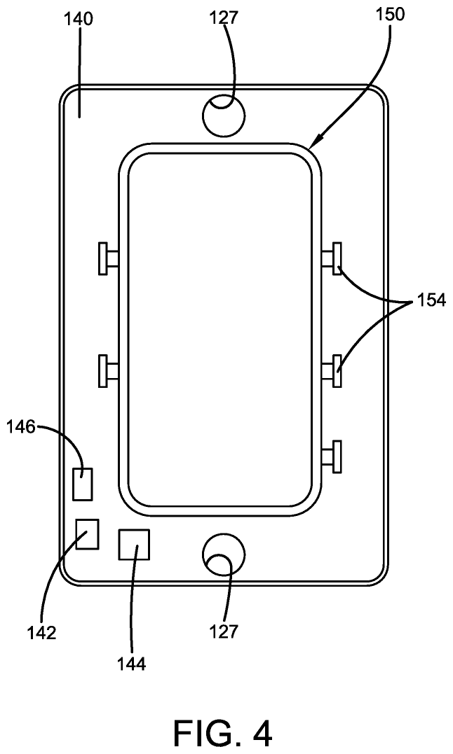

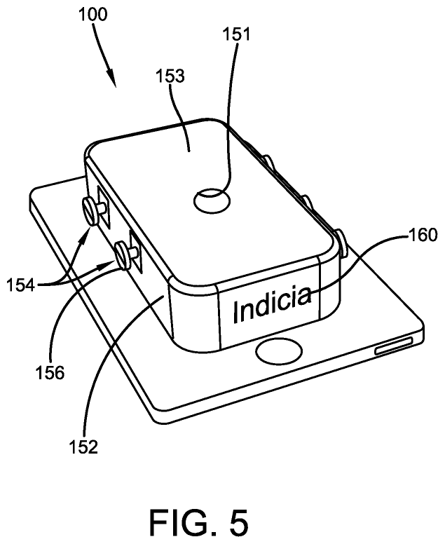

As best seen in FIG. 4 and FIG. 5, the sidewalls 152 of the box 150 may further be comprised of at least one terminal 154 that allows out, in, and ground wires to be attached to the device 100 to supply electrical power to a battery 146 of the device 100. The terminals 154 may further be color-coded to help a user identify which terminals 154 correspond to out, in, and ground wiring. Further, each terminal 154 may have a screw head 156 that has a Phillips or flat screw head that allows each terminal 154 to be turned and extended into or out of the box 150 to aid in securing wiring to the device 100.

The top surface 120 may also be comprised of at least one button 124, at least one speaker 125, and at least one microphone 126. The microphone 126 allows one user to speak into the device 100 to speak to another user who is near another device 100. For example, in a scenario wherein the device 100 is used as a light switch in each room of a home, users in differing rooms can use the device 100 within each room as an intercom system by talking into the microphone 126 of each device 100, wherein the voice communication is then played externally from the speaker 125 of each device 100. The button 124 further allows a user to activate or mute the speaker 125 and/or microphone 126 (and activate/mute a smart assistant 202, which will be described more fully below). The button 124 may also be used to control the light switch 121 or to turn the device 100 on or off.

The side surface 130 of the front plate 110 is further comprised of at least one LED light 132 that may be arranged in an LED light array. The light 132 may illuminate any color known in the art and may have a plurality of brightness levels, wherein both are control by the button 124 or by a mobile application 200. In this manner, the LED light 132 illuminates the area around the device 100 and can serve as a light source within a room.

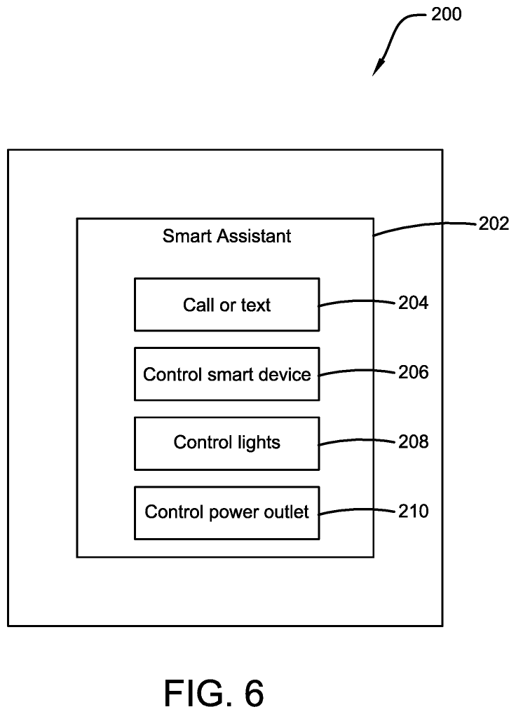

FIG. 6 illustrates a graphical view of one potential embodiment of a mobile application 200 of a smart plate device 100 of the present invention in accordance with the disclosed architecture. The device 100 is also comprised of a mobile application 200 that can be used on any smart device such as, but not limited to a smart phone or tablet. The application 200 may also be used on a computer in the form of a website or software. The mobile application 200 communicates with at least one transmitter 142 which may be located on the rear surface 140 of the front plate 110 in one embodiment. The transmitter 142 may transmit a Wi-Fi, Bluetooth, RFID, etc. signal that places the mobile application 200 in electrical communication with the front plate 110. In this manner, commands made by the mobile application 200 can be executed via a processor 144 of the front plate 110.

The mobile application 200 may have a voice-activated smart assistant 202, or can be used with any voice-activated smart assistant known in the art. In this manner, the functions of the device 100 can be controlled via various voice commands. For example, using the smart assistant 202, the device 100 can be used to make a phone call or text message 204 to any party [Block 204], including emergency services. The smart assistant 202 may also allow a user to control other smart devices [Block 206] such as, but not limited to: TV's, speakers, garage door openers, appliances, etc. that can also be placed in electrical communication with the device 100 via the transmitter 142. Using a voice command, a user can also instruct the smart assistant 202 to turn the light switch 121 of the front plate 110 on or off to turn lights controlled by the switch 121 on or off [Block 208]. Similarly, using a voice command, a user can instruct the smart assistant 202 to turn the power supply to the power outlet 122 on or off [Block 210]. It should be appreciated that the device 100 may also have a plurality of other voice-command related functions.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart plate device” and “device” are interchangeable and refer to the smart plate device 100 of the present invention.

Notwithstanding the forgoing, the smart plate device 100 of the present invention and its various components can be of any suitable size and configuration as is known in the art without affecting the overall concept of the invention, provided that they accomplish the above-stated objectives. One of ordinary skill in the art will appreciate that the size, configuration and material of the smart plate device 100 as shown in the FIGS. are for illustrative purposes only, and that many other sizes and shapes of the smart plate device 100 are well within the scope of the present disclosure. Although the dimensions of the smart plate device 100 are important design parameters for user convenience, the smart plate device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart plate device comprising:
a front plate comprised of a top surface, a side surface and a rear surface;
a button;
a speaker;
a microphone;
an LED light;
a transmitter; and
a processor.

2. The smart plate device of claim 1, wherein the top surface is further comprised of at least one of a light switch, a power outlet and a USB port.

3. The smart plate device of claim 1, wherein the top surface is further comprised of a touch screen.

4. The smart plate device of claim 1, wherein the smart plate device is controllable with a voice-activated smart assistant.

5. A smart plate device comprising:
a front plate comprised of a top surface, a side surface and a rear surface;
a button;
a speaker;
a microphone;
an LED light;
a transmitter; and
a box attached to the rear surface and further comprised of a terminal.

6. The smart plate device of claim 5, wherein the top surface is further comprised of at least one of a light switch, a power outlet and a USB port.

7. The smart plate device of claim 5, wherein the top surface is further comprised of a touch screen.

8. The smart plate device of claim 7, wherein the touch screen controls the smart plate device.

9. The smart plate device of claim 5, wherein a voice communication from the microphone of the smart plate device can be played externally from a speaker of a second smart plate device.

10. The smart plate device of claim 5, wherein the smart plate device can be controlled with a voice-activated smart assistant.

11. A smart plate device comprising:
a front plate comprised of a top surface, a side surface and a rear surface;
a speaker;
a microphone;
an LED light;
a transmitter; and
a mobile application.

12. The smart plate device of claim 11, wherein the top surface is further comprised of at least one of a light switch, a power outlet and a USB port.

13. The smart plate device of claim 11, wherein the mobile application is further comprised of a voice-activated smart assistant.

14. The smart plate device of claim 13, wherein the voice-activated smart assistant controls a plurality of functions of the smart place device.

15. The smart plate device of claim 14, wherein the voice-activated smart assistant can initiate a phone call or a text message.

16. The smart plate device of claim 13 further comprising a button that activates or mutes the voice-activated smart assistant.

17. The smart plate device of claim 16, wherein the button controls the smart plate device.

18. The smart plate device of claim 11, wherein the top surface is further comprised of a touch screen.

19. The smart plate device of claim 11, wherein a voice communication from the microphone of the smart plate device can be played externally from a speaker of a second smart plate device.

20. The smart plate device of claim 11, wherein the LED light is controlled by the mobile application.
